(19) United States
(12) Patent Application Publication
(10) Pub. No.: US 2011/0044669 A1
(43) Pub. Date: Feb. 24, 2011

(54) CIRCUIT FOR CONTROLLING A NUMBER OF MOTORS

(75) Inventor: Jean Francois Leon, Creteil Cedex (FR)

Correspondence Address: OSHA LIANG L.L.P., TWO HOUSTON CENTER, 909 FANNIN, SUITE 3500, HOUSTON, TX, 77010, US

(73) Assignee: VALEO SECURITE HABITACLE, Creteil Cedex (FR)

(21) Appl. No.: 12/746,841

(22) PCT Filed: Dec. 11, 2008
(86) PCT No.: PCT/EP08/67302

§ 371 Date: Nov. 10, 2010

(30) Foreign Application Priority Data
Dec. 11, 2007 (FR) 0708643

(51) Int. Cl. H02P 7/29; B60N 2/02; E05F 15/04

(52) U.S. Cl. 388/829; 297/344.1; 49/358

(57) ABSTRACT

The invention relates to a circuit for controlling a number of DC motors (M1, M2) capable of being controlled independently of one another, comprising, for each motor (M1, M2), an H-bridge (1A, 1B) made up of a first branch (3) and of a second branch (5), which bridge is intended for the control of the associated motor. According to the invention, the said second branches (5) of the H-bridges (1A, 1B) are produced in the form of two switches (7, 9) forming a branch common to all the H-bridges and rated to accept a current equivalent to the sum of the drive currents so that the said motors (M1, M2) can be controlled simultaneously and independently by applying associated control signals to the first branches (3).

The invention relates to the control of electric motors, in particular of direct-current motors.

In the motorized systems of motor vehicles, such as systems for motorizing the trunk or the seat, the technical trend is toward the use of a number of small electric motors, allowing a reduced space requirement, instead of a single large motor. In particular, in the motorized systems of openings (tailgates or trunks), it is preferable to use two tubular drive actuators having a space requirement equivalent to that of the conventional pneumatic assistance cylinders, each of the actuators being fitted with an electric motor and being placed, for example, in parallel with the pneumatic cylinders or in the place of the latter.

This increase in the number of motors generates the requirement to control these various motors in a secure and effective manner.

Usually, a motor requires a control of the direction and of the speed of rotation. In a known manner, this function is provided by an H-bridge making it possible to reverse the polarity and vary the speed of the motors.

Conventionally, an H-bridge comprises four switches arranged substantially in the shape of an H, the motor to be controlled being situated in the middle of the four switches and controlled as a function of the on state or off state of the switches.

To control a number of motors, provision is made to place in parallel a number of H-bridges. However, this configuration is costly and bulky.

Reference may be made, for example, to patent application US 2007/0075657 which proposes a control of a number of motors with the aid of a multiple H-bridge comprising several H-bridges in parallel and a pulse-control circuit allowing the various motors to be controlled.

Specifically, this configuration causes a considerable space requirement due to the number of components that are necessary, which also causes bad heat dissipation.

It is also known practice to control a number of direct-current motors from a single H-bridge. However, this configuration does not allow the independent control of the various motors. Certain applications, such as for example the opening or closing of a trunk, require an independent and simultaneous control of each motor to allow an effective actuation of the trunk and to prevent a twisting movement on the trunk.

The object of the invention is therefore to alleviate these drawbacks of the prior art by proposing an independent and simultaneous control of a number of motors in a simple and low-cost manner.

More precisely, the object of the invention is to provide a circuit for controlling a number of direct-current motors capable of being controlled independently of one another, comprising for each motor an H-bridge consisting of a first branch and of a second branch, designed for the control of the associated motor, characterized in that said second branches of the H-bridges are made by two switches forming a branch common to all the H-bridges and rated to receive a current equivalent to the sum of the drive currents so that said motors can be controlled simultaneously and independently by the application of command signals associated with the first branches.

A further subject of the invention is a control circuit of which all the H-bridges are in one and the same case.

According to a preferred embodiment, each switch of the first branches of the H-bridges is capable of receiving an associated pulse width modulation, PWM, signal.

In this case, the PWM signals are independent of one another.

Advantageously, the control circuit comprises an upper portion comprising upper switches connected to a common power supply, and a lower portion comprising lower switches connected to ground.

Preferably, the control circuit comprises means for measuring the current for controlling said motors.

The invention also relates to a device for controlling a number of motors in a motor vehicle comprising a control circuit according to the invention.

The invention also relates to a system for the motorized assistance of an opening for a motor vehicle, the system comprising at least a first actuator and a second actuator for driving the opening from a first position to a second position, designed to be mounted between the bodywork of the vehicle and the opening, preferably on the opposite sides of the opening, each actuator being fitted with an electric motor and with a mechanism converting the rotary movement of the electric motor to a movement making it possible to move the opening, comprising such a control device.

The invention also relates to a system for assisting the actuation of elements of a seat of a motor vehicle, comprising seat elements that can be moved by means of an individual actuator which comprises a direct-current motor, and comprising a control device as specified above.

Other features and advantages of the invention will become clearer on reading the following description of a preferred embodiment, given as a simple example that is illustrative and nonlimiting, and the appended drawings in which:

FIG. 1 illustrates a circuit for controlling two direct-current motors according to the invention;

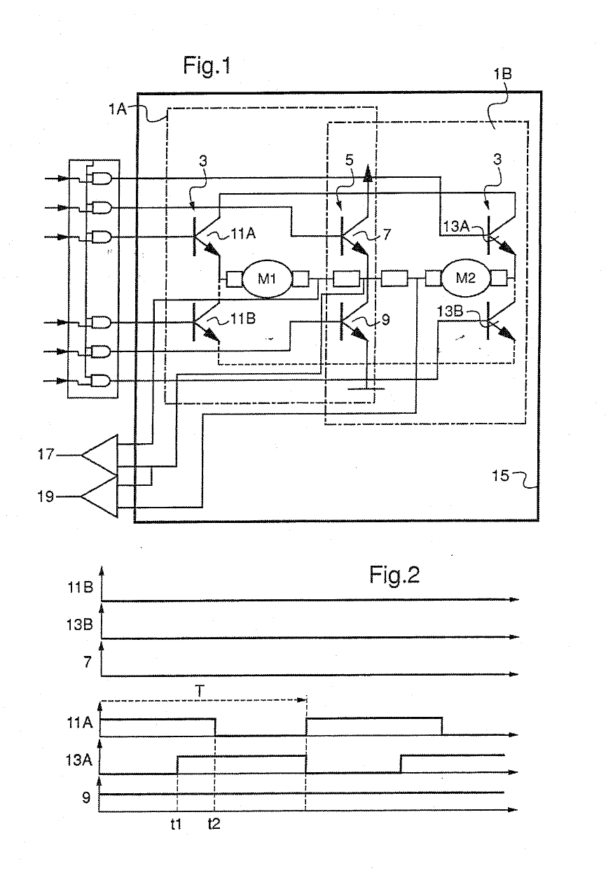

FIG. 2 is a timing diagram of the evolution of the control signals of the switches for controlling the motors in a first direction;

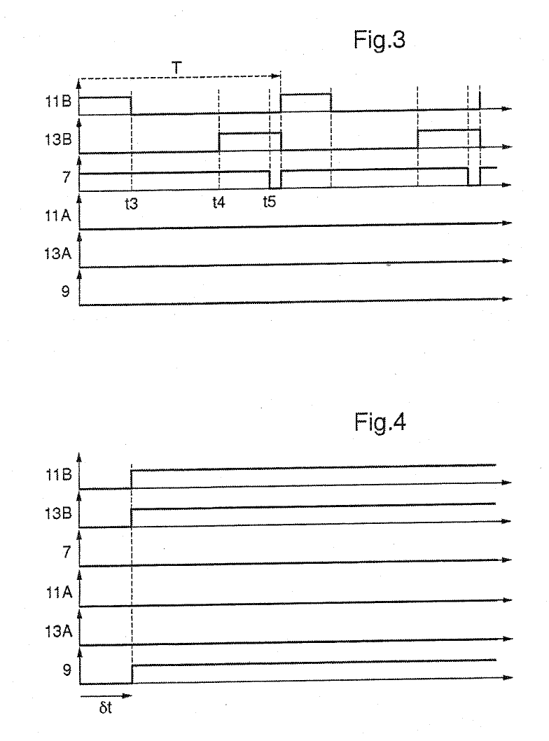

FIG. 3 is a timing diagram of the evolution of the control signals of the switches for controlling the motors in a second direction;

FIG. 4 is a timing diagram of the evolution of the control signals of the switches for controlling the braking of the motors;

FIG. 5 illustrates a system for the motorized assistance of an opening of a motor vehicle comprising a control circuit according to the invention;

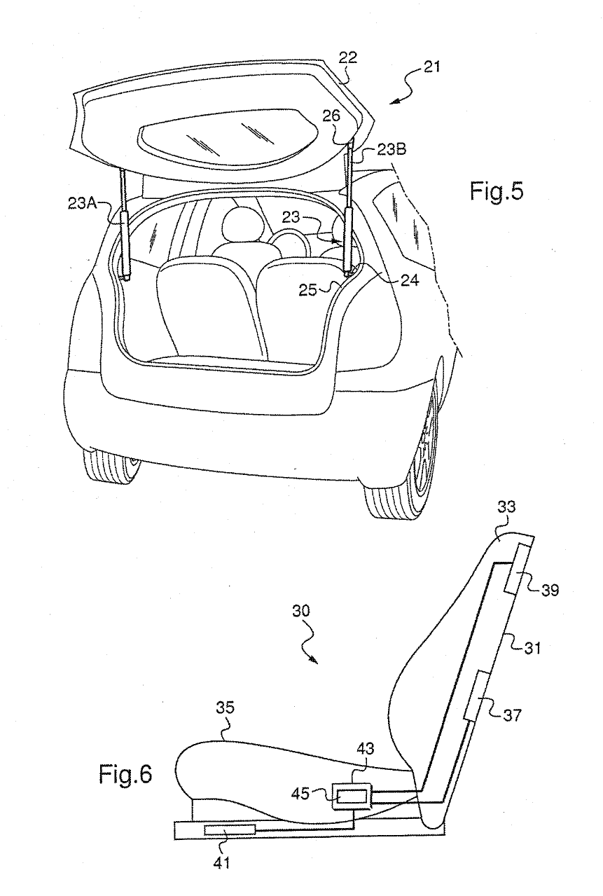

FIG. 6 illustrates a motor vehicle seat fitted with a system for the motorized assistance of the actuation of a seat element comprising a control circuit according to the invention.

FIG. 1 illustrates a circuit for controlling two direct-current motors M1 and M2 capable of being controlled independently of one another according to the invention.

The control circuit comprises, for each motor M1, M2, an H-bridge respectively 1A, 1B. Each H-bridge 1A, 1B consists of a first branch 3 and of a second branch 5, and is designed to control the associated motor M1, or M2.

The second branches 5 of the H-bridges are made by two switches 7, 9 forming a branch 5 common to both H-bridges 1A, 1B.

The reduction in the number of switches makes it possible to reduce the amount of heat produced, thus allowing the use of heat-dissipation radiators of smaller dimension or to dispense with radiators while allocating a copper surface to each switch on the printed circuit in order to limit their temperature, which allows a lesser space requirement.

The switches 7, 9 are rated to receive a current equivalent to the sum of the two drive currents so that the two motors M1, M2 can be controlled simultaneously and independently by the application of control signals associated with the first branches. Moreover, this rating does not require doubling the size or the price of these switches 7, 9 which makes it possible to have a simple and low-cost system.

Specifically, the maximum value of the control signal making it possible to limit the current to its maximum value in each motor M1, M2 is known by the characteristics of the motor and is less than 100%.

The two motors M1, M2 and the associated H-bridges 1A, 1B are installed in one and the same case 15.

The branch 3 of the H-bridge 1A is formed by two switches 11A, 11B. Similarly, the branch 3 of the H-bridge 1B is formed by two switches 13A, 13B.

The first motor M1 is situated between the switches 11A, 11B and 7, 9 and the second motor M2 is situated between the switches 7, 9 and 13A, 13B.

Each switch 11A, 11B, 13A and 13B is capable of receiving an associated pulse width modulation, PWM, signal so as to allow the control of the direction and of the speed of rotation of each motor. The control of the motors M1, M2 associated with the PWM technology can be achieved in phase opposition which allows a reduction in the power dissipated by the switches and in the disturbance of electromagnetic compatibility.

The circuit comprises an upper portion connected to a common power supply and a lower portion connected to ground. The upper portion comprises the upper switches 11A, 7, 13A connected together to the power supply, and the lower portion comprises the lower switches 11B, 9, 13B connected together to ground.

Means 17, 19 for measuring the current for controlling the two motors M1, M2 are installed in order to control the balance of the forces so as to prevent distortions at the object actuated by the motors M1, M2.

The operation of the circuit according to the invention will now be described.

As illustrated in the timing diagrams of FIGS. 2 to 4, the PWM signals are superposed and therefore independent of one another and allow a control of the direction and of the speed of rotation of the two motors M1, M2.

With reference to the timing diagram of FIG. 2, the control of the two motors M1, M2 in a first direction is provided by the current traveling in a first direction defined by the fact that the switches 11A, 9, 13A are on state and that the switches 11B, 7, 13B are off state.

Specifically, the switches 11B, 7, 13B receive a “low” signal throughout the control in the first direction.

The period of a PWM signal is T, and during this period T, the switches 11A, 9, 13A receive alternating “high” or “low” signals.

For the circuit to operate correctly, in the control cycle in the first direction, the switch 11A receives a “high” signal and the switch 13A receives a “low” signal at the beginning of each period.

The duration of the “high” signal received by the switch 11A is defined by the moment t2 after which it then receives a “low” signal up to the moment T. Similarly, the duration of the “low” signal received by the switch 13A is defined by the moment t1 after which it then receives a “high” signal up to the moment T.

Referring now to the timing diagram of FIG. 3, during the control of the two motors M1, M2 in a direction that is the reverse of the first, the current travels in a second direction defined by the fact that the switches 11B, 7, 13B are on state and the switches 11A, 9, 13A are off state.

Specifically, it is the switches 11A, 9, 13A that receive a “low” signal throughout the control in the second direction, while the switches 11B, 7, 13B receive alternating “high” or “low” signals.

For the circuit to operate correctly, in a control cycle in the second direction, the switch 11B receives a “high” signal and the switch 13B receives a “low” signal at the beginning of each period.

The duration of the “high” signal received by the switch 11B is defined by the moment t3 after which it receives a “low” signal up to the moment T. Similarly, the duration of the “low” signal received by the switch 13B is defined by the moment t4 after which it receives a “high” signal up to the moment T. Finally, the duration of the “high” signal received by the switch 7 is defined by the moment t5 after which it receives a “low” signal up to the moment T.

As illustrated in the timing diagram of FIG. 4, the braking is provided by a short-circuiting of the direct-current motors. Specifically the switches 11B, 9, 13B are on state and receive a “high” signal throughout the cycle and the switches 11A, 7, 13A are off state and receive a “low” signal throughout the cycle. A latency time δt during which all of the switches receive a “low” signal precedes this operation. The short-circuit can also be achieved by making the switches 11B, 9, 13B off state and by leaving the switches 11A, 7, 13A on state.

According to a preferred embodiment, such a control circuit is installed in a device for controlling a number of electric motors present in a motor vehicle.

FIG. 5 shows a motor vehicle 21 comprising an opening 22 such as a tailgate. Naturally, an opening of a motor vehicle also includes the trunk or else the side doors of the vehicle.

This vehicle 21 is fitted with a system 23 for motorized assistance of an opening of a motor vehicle comprising at least a first actuator 23A and a second actuator 23B for driving the opening 22 from a first position to a second position. Accordingly, one end of each actuator 23A, 23B is connected at a first articulation 24 to the bodywork 25 of the vehicle and the other end is connected at a second articulation 26 on the tailgate 22. The first actuator 23A and second actuator 23B are fitted with two direct-current electric motors controlled by a control device comprising a control circuit as specified above.

According to another embodiment, such a control device can be applied in a system for assisting the actuation of elements of a motor vehicle seat comprising a number of motors.

FIG. 6 illustrates a vehicle seat 30 which conventionally comprises a back 31, a headrest 33, a squab 35. This seat is fitted with a motorized-assistance system with a first actuator 37 for allowing the back 31 to tilt, a second actuator 39 for the movement of the headrest 33, a third actuator 41 for the movement from front to rear of the seat squab 35. Each actuator of a seat element comprises a direct-current motor in order to carry out the desired movement. All the direct-current motors are connected to one and the same case 43 comprising the control device 45 as specified above, allowing the independent and simultaneous actuation of all the seat elements.

Such a system for assisting in the actuation of elements of a seat comprising a number of motors may also be used for a motorized seat of any other means of transport.

It is understood that such a control device makes it possible to obtain a simultaneous and independent control of the various motors.

Moreover, the reduction in the number of switches in the control circuit makes it possible to reduce the amount of heat produced, thus allowing the use of heat-dissipation radiators of smaller dimension in order to limit their temperature, which allows a lesser space requirement, without needing to rerate the common switches by doubling their size or their price, which makes it possible to have a simple and low-cost system.

1. A circuit for controlling a number of direct-current motors capable of being controlled independently of one another, comprising:
for each motor, an H-bridge comprising a first branch and a second branch, designed for the control of the associated motor,
wherein said second branches of each H-bridge are made by two switches forming a branch common to all the H-bridges and rated to receive a current equivalent to a sum of drive currents so that said motors are controlled simultaneously and independently by application of command signals associated with the first branches.

2. The control circuit as claimed in claim 1, wherein all the H-bridges are in a single case.

3. The control circuit as claimed in claim 1, wherein each switch of the first branches of the H-bridges is capable of receiving an associated pulse width modulation (PWM) signal.

4. The control circuit as claimed in claim 3, wherein the PWM signals are independent of one another.

5. The control circuit as claimed in claim 1, further comprising:
an upper portion comprising upper switches connected to a common power supply, and
a lower portion comprising lower switches connected to ground.

6. The control circuit as claimed in claim 1, further comprising means for measuring the current for controlling said motors.

7. A device for controlling a number of motors in a motor vehicle, comprising a control circuit as claimed in claim 1.

8. A system for motorized assistance of an opening of a motor vehicle, the system comprising:
at least a first actuator and a second actuator for driving the opening from a first position to a second position, designed to be mounted between bodywork of the vehicle and the opening, each actuator located on the opposite sides of the opening, each actuator being fitted with an electric motor and with a mechanism converting the rotary movement of the electric motor to a movement making it possible to move the opening; and,
a device for controlling a number of motors in a motor vehicle, comprising:
a circuit for controlling a number of direct-current motors capable of being controlled independently of one another, comprising for each motor, an H-bridge comprising a first branch and a second branch,
wherein said second branches of each H-bridge are made by two switches forming a branch common to all the H-bridges and rated to receive a current equivalent to a sum of drive currents so that said motors are controlled simultaneously and independently by application of command signals associated with the first branches.

9. A system for assisting the actuation of elements of a seat of a motor vehicle, comprising:
seat elements that can be moved by means of an individual actuator which comprises a direct-current motor; and
a device for controlling a number of motors in a motor vehicle, comprising:
a circuit for controlling a number of direct-current motors capable of being controlled independently of one another, comprising for each motor, an H-bridge comprising a first branch and a second branch,
wherein said second branches of each H-bridge are made by two switches forming a branch common to all the H-bridges and rated to receive a current equivalent to a sum of drive currents so that said motors are controlled simultaneously and independently by application of command signals associated with the first branches.
